(19) United States
(12) Patent Application Publication
(10) Pub. No.: US 2026/0109156 A1
(43) Pub. Date: Apr. 23, 2026

(54) PRINTER PAPER MANAGEMENT SYSTEM

(71) Applicant: Teco Image Systems Co., Ltd., Taipei City (TW)

(72) Inventor: Shih-Kuo Chen, Taipei City (TW)

(21) Appl. No.: 18/932,283

(22) Filed: Oct. 30, 2024

(30) Foreign Application Priority Data
Oct. 23, 2024 (TW) 113140221

(51) Int. Cl. B41J 3/60; B41J 11/00

(52) U.S. Cl. CPC B41J 3/60; B41J 11/0095

(57) ABSTRACT

A printer paper management system is disclosed and includes a printing device, a driving-and-controlling module, an image-capturing module and an image-processing module. The printing device is configured to perform a printing operation in a printing position. The driving-and-controlling module is connected to the printing device to transport a paper from the paper cassette to the printing position for the printing device printing on the paper. The image-capturing module is arranged between the paper cassette and the printing position, and configured to capture an image of the paper before the paper is transported from the paper cassette to the printing position. The image-processing module is connected to the image-capturing module and the driving-and-controlling module, receives and processes the image of the paper to extract image features, which is transmitted to the driving-and-control module. The driving-and-controlling module determines whether to use the paper based on the image features for a printing operation.

### CROSS-REFERENCE TO RELATED APPLICATION

This application claims priority to Taiwan Patent Application No. 113140221, filed on Oct. 23, 2024. The entireties of the above-mentioned patent application are incorporated herein by reference for all purposes.

### FIELD OF THE INVENTION

The present disclosure relates to a printer system, and more particularly to a printer paper management system using image recognition technology to automatically detect whether the paper has been used and select an unused side for printing, so that the paper consumption is sufficiently reduced and the work efficiency is improved.

### BACKGROUND OF THE INVENTION

Generally speaking, common single-function printers on the market only have basic printing functions but lack intelligent paper management functions. If users want to use recycled paper for printing, they usually need to manually check whether the paper is still usable and place the paper in the correct direction. However, the manual inspection of paper is not only time-consuming, but also error-prone, thus reducing work efficiency. Furthermore, the manual method of checking paper can easily misjudge the used paper as the unused due to human error, thus leading to waste of paper and printing materials. Notably, paper waste will not only increase business costs, but also impose a burden on the environment.

Therefore, there is a need of providing a printer paper management system using image recognition technology to automatically detect whether the paper has been used and select an unused side for printing, so that the paper consumption is sufficiently reduced, the work efficiency is improved, and the drawbacks encountered from the prior arts are obviated.

### SUMMARY OF THE INVENTION

It is an object of the present disclosure to provide a printer paper management system using image recognition technology to automatically detect whether the paper has been used and select an unused side for printing, so that the paper consumption is sufficiently reduced and the work efficiency is improved. It conforms to the current society's emphasis on environmental protection and helps promote the development of green offices.

It is another object of the present disclosure to provide a printer paper management system. An image-capturing module, such as a pair of cameras or a pair of scanning elements, is placed on the conveyance path between the paper tray and the printing position, and images of the front side and the back side of the paper are captured before the paper reaches the printing position. The images of the front side and the back side of the paper are received and processed by an image-processing module to extract the image features and determine the usage status of the front side and the back side of the paper. Based on the image features, the driving-and-controlling module can determine whether to print on the current paper, automatically turn pages for use, or eject the paper and load another paper for printing. Regardless of whether it is a single-sided printing operation or a double-sided printing operation, the printer paper management system can automatically detect and select the paper for printing, so as to greatly improve the work efficiency. The image-processing module uses precise image recognition technology and image processing algorithms to preprocess the images, and the text, images and other features on the paper are analyzed to extract the useful image features. It can accurately determine the usage status of the paper and execute the printing operation accordingly. The paper waste is sufficiently reduced. It has advantages of complying with environmental protection trends, and reducing the burden on the environment. On the other hand, through the automatic paper selection function of the printer paper management system, the users do not need to perform manual selection operations, and can also avoid problems such as paper misplacement, misprinting, and reprinting. It provides the users with a smarter and more convenient printing experience. The present disclosure includes the industrial applicability and the inventive steps.

In accordance with an aspect of the present disclosure, a printer paper management system is provided and includes a printing device, a driving-and-controlling module, an image-capturing module and an image-processing module. The printing device is configured to perform a printing operation in a printing position. The driving-and-controlling module is connected to the printing device to transport a paper from a paper cassette to the printing position for the printing device printing on a front side of the paper, wherein the driving-and-controlling module allows the front side of the paper to be turned over as a reverse side. The image-capturing module is arranged between the paper cassette and the printing position, and configured to capture an image of the paper before the paper is transported from the paper cassette to the printing position. The image-processing module is connected to the image-capturing module and the driving-and-controlling module, receives and processes the image of the paper to extract image features for transmitting to the driving-and-control module, wherein the driving-and-controlling module determines whether to use the paper based on the image features for a printing operation.

In an embodiment, the driving-and-controlling module determines whether the front side of the paper is in a used state or an unused state based on the image features.

In an embodiment, when the front side of the paper is determined to be in the unused state, the driving-and-controlling module transports the paper to the printing position for the printing device to perform the printing operation on the front side of the paper.

In an embodiment, when the front side of the paper is determined to be in the used state, the driving-and-controlling module flips the front side of the paper to become the reverse side, and transports the paper to the printing position for the printing device to perform the printing operation on another side of the paper.

In an embodiment, when the front side of the paper is determined to be in the used state, the driving-and-controlling module takes the paper away from the printing position, and the driving-and-controlling module loads another paper from the paper cassette.

In an embodiment, the driving-and-controlling module transports the paper from the paper cassette to the printing position along a first transport path, and the image-capturing module is arranged by a lateral side of the first transport path and spatially corresponding to the front side of the paper.

In an embodiment, the driving-and-controlling module transports the paper from the printing position to flip the paper along a second transport path before transporting the paper back to the printing position, and transports the paper from the printing position to a paper output tray along a third transport path, wherein a first turning point is formed between the second transport path and the third transport path, a second turning point is formed between the second transport path and the first transport path, and the first turning point and the second turning point are located behind the printing position and in front of the printing position, respectively.

In an embodiment, the image-capturing module is located between the second turning point and the printing position.

In an embodiment, the image features include text areas, image areas, edges or black and white contrast.

In accordance with another aspect of the present disclosure, a printer paper management system is provided and includes a printing device, a driving-and-controlling module, an image-capturing module and an image-processing module. The printing device is configured to perform a printing operation in a printing position. The driving-and-controlling module is connected to the printing device to transport a paper from a paper cassette to the printing position for the printing device printing on a front side of the paper, wherein the driving-and-controlling module allows flipping the paper. The image-capturing module is arranged between the paper cassette and the printing position, and configured to capture an image of the paper before the paper is transported from the paper cassette to the printing position. The image-processing module is connected to the image-capturing module and the driving-and-controlling module, receives and processes the image of the paper to extract image features for transmitting to the driving-and-control module, wherein the driving-and-controlling module determines whether to use the paper based on the image features for a printing operation.

In an embodiment, the driving-and-controlling module determines whether the front side and a reverse side of the paper are in a used state or an unused state based on the image features, respectively.

In an embodiment, when the front side of the paper is determined to be in the unused state, the driving-and-controlling module transports the paper to the printing position for the printing device to perform the printing operation on the front side of the paper.

In an embodiment, when the front side of the paper is determined to be in the used state and the reverse side of the paper is determined to be in the unused state, the driving-and-controlling module flips the paper, and transports the paper to the printing position for the printing device to perform the printing operation on the paper.

In an embodiment, when the front side of the paper and the reverse side of the paper are determined to be in the used state, the driving-and-controlling module takes the paper away from the printing position, and the driving-and-controlling module loads another paper from the paper cassette.

In an embodiment, when the front side of the paper and the reverse side of the paper are determined to be in the unused state, the driving-and-controlling module transports the paper to the printing position for the printing device to perform the printing operation on the front side of the paper, and then flips the paper and transport the paper to the printing position for the printing device to perform the printing operation on the paper, wherein the printing operation is a double-sided printing operation.

In an embodiment, when either the front side or the reverse side of the paper is determined to be in the used state, the driving-and-controlling module takes the paper away from the printing position, and the driving-and-controlling module loads another paper from the paper cassette, wherein the printing operation is a double-sided printing operation.

In an embodiment, the image-capturing module includes a pair of cameras or a pair of scanning elements, which are spatially corresponding to each other and configured to capture the image of the paper when the driving-and-controlling module transports the paper through the image-capturing module, wherein the image includes a front-side image and a reverse-side image, wherein the driving-and-controlling module determines whether the front side of the paper is in a used state or an unused state based on the image features extracted from the front-side image; and the driving-and-controlling module determines whether a reverse side of the paper is in a used state or an unused state based on the image features extracted from the reverse-side image.

In an embodiment, the driving-and-controlling module transports the paper from the paper cassette to the printing position along a first transport path, and the image-capturing module is arranged by a lateral side of the first transport path and spatially corresponding to the front side of the paper.

In an embodiment, the driving-and-controlling module transports the paper from the printing position to flip the paper along a second transport path before transporting the paper back to the printing position, and transports the paper from the printing position to a paper output tray along a third transport path, wherein a first turning point is formed between the second transport path and the third transport path, a second turning point is formed between the second transport path and the first transport path, and the first turning point and the second turning point are located behind the printing position and in front of the printing position, respectively.

In an embodiment, the image-capturing module is located between the second turning point and the printing position.

### BRIEF DESCRIPTION OF THE DRAWINGS

The above contents of the present disclosure will become more readily apparent to those ordinarily skilled in the art after reviewing the following detailed description and accompanying drawings, in which:

FIG. 1 is a schematic structural diagram illustrating a printer paper management system according to a first embodiment of the present disclosure; and

FIG. 2 is a schematic structural diagram illustrating a printer paper management system according to a second embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. Further, spatially relative terms, such as “front,” “reverse,” “behind,” “back,” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. When an element is referred to as being “connected,” or “coupled,” to another element, it can be directly connected or coupled to the other element or intervening elements may be present. Although the wide numerical ranges and parameters of the present disclosure are approximations, numerical values are set forth in the specific examples as precisely as possible. In addition, although the “first,” “second,” “third,” and the like terms in the claims be used to describe the various elements can be appreciated, these elements should not be limited by these terms, and these elements are described in the respective embodiments are used to express the different reference numerals, these terms are only used to distinguish one element from another element. For example, a first element could be termed a second element, and, similarly, a second element could be termed a first element, without departing from the scope of example embodiments.

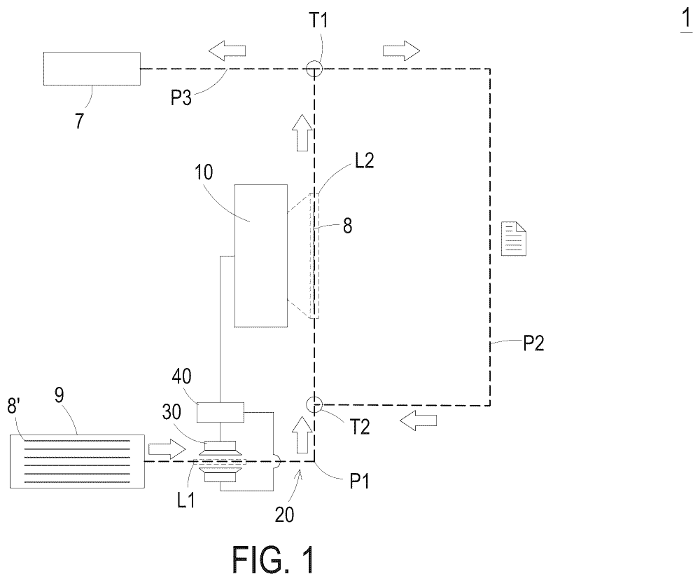

FIG. 1 is a schematic structural diagram illustrating a printer paper management system according to a first embodiment of the present disclosure Referring to FIG. 1, the present disclosure provides a printer paper management system 1, which is used to automatically detect paper and perform single-sided or double-sided printing operations accordingly. In the embodiment, the printer paper management system 1 includes a printing device 10, a driving-and-controlling module 20, an image-capturing module 30 and an image-processing module 40. The printing device 10 is configured to perform a printing operation in a printing position L2. The driving-and-controlling module 20 is connected to the printing device 10 to transport a paper 8 from a paper cassette 9 to the printing position L2 for the printing device 10 printing on a front side of the paper 8. Moreover, the driving-and-controlling module 20 allows the front side of the paper 8 to be turned over as a reverse side. The image-capturing module 30 is arranged between the paper cassette 9 and the printing position L2 of the printing device 10, and configured to capture an image of the paper 8 before the paper 8 is transported from the paper cassette 9 to the printing position L2. The image-processing module 40 is connected to the image-capturing module 30 and the driving-and-controlling module 20, receives and processes the image of the paper 8 to extract image features for transmitting to the driving-and-control module 20. In the embodiment, the driving-and-controlling module 20 determines whether to use the paper 8 based on the image features for a printing operation, or to take the paper 8 away from the printing position L2 or to flip the paper 8.

In the embodiment, the image-capturing module 30 includes a pair of cameras or a pair of scanning elements, which are spatially corresponding to each other and configured to capture the image of the paper 8 when the driving-and-controlling module 20 transports the paper 8 through an image-capturing position L1 of the image-capturing module 30. In the embodiment, when the paper 8 is transported through the image-capturing position L1 of the image-capturing module 30, the pair of cameras or the pair of scanning elements of the image-capturing module 30 are spatially corresponding to the front side and the reverse side of the paper 8 respectively. In other words, the image captured by the image-capturing module 30 when the paper 8 passes through the image-capturing position L1 includes a front-side image and a reverse-side image of the paper 8. In the embodiment, the driving-and-controlling module 20 determines whether the front side of the paper 8 is in a used state or an unused state based on the image features extracted from the front-side image; and the driving-and-controlling module 20 determines whether a reverse side of the paper is in a used state or an unused state based on the image features extracted from the reverse-side image.

In the embodiment, when the printing operation performed by the printing device 10 is a single-sided printing operation, the driving-and-controlling module 20 can determine the transport path of the paper 8 based on the image features of the paper 8, and determine whether the printing device 10 uses the paper 8 to perform the printing operation. When the front side of the paper 8 is determined to be in the unused state, the driving-and-controlling module 20 transports the paper 8 to the printing position L2 along a first transport path P1, so that the printing device 20 can perform the printing operation on the front side of the paper 8. When the front side of the paper 8 is determined to be in the used state and the reverse side of the paper is determined to be in the unused state, the driving-and-controlling module 20 transports the paper 8 along the first transport path P1 to the printing position L2, but the printing device 10 does not perform the printing operation. Then, the driving-and-controlling module 20 transports the paper 8 and flips the front side of the paper 8 as a reverse side along a second transport path P2, so that the paper 8 is transported to the printing position L2 again for the printing device 10 to perform the single-sided printing operation on the other side of the paper 8. In addition, when the front side of the paper 8 and the reverse side of the paper 8 are determined to be in the used state, the driving-and-controlling module 20 takes the paper 8 away from the printing position L2 along a third transport path P3, and ejects the paper 8 to the paper output tray 7. At the same time, the driving-and-controlling module 20 further loads another paper 8′ from the paper cassette 9. The printer paper management system 1 will process the paper 8′according to the aforementioned process. It will not be redundantly described again.

Notably, in the embodiment, the driving-and-controlling module 20 is, for example, combined with a paper feeding mechanism and a control unit (not shown), and it allows the transport paths of the paper 8 to be set according to the application requirements. In the embodiment, the driving-and-controlling module 20 transports the paper 8 from the paper cassette 9 to the printing position L2 along the first transport path P1. Preferably but not exclusively, the image-capturing module 30 is arranged by a lateral side of the first transport path P1. In that, when the paper 8 is transported along the first transport path P1, the paper 8 will pass through the image-capturing position L1 of the image-capturing module 30. In an embodiment, the image-capturing module 30 includes only one single camera or one scanning element and spatially corresponds to the front side of the paper 8. When the front side of the paper 8 is determined to be in the used state, the driving-and-controlling module 20 directly takes the paper 8 away from the printing position L2 along the third transport path P3. The driving-and-controlling module 20 does not flip the paper 8 but directly loads another paper 8′ from the paper cassette 9. Certainly, the present disclosure is not limited thereto. In the embodiment, the driving-and-controlling module 20 transports the paper 8 from the printing position L2 to flip the paper 8 along the second transport path P2 before transporting the paper 8 back to the printing position L2, and transports the paper 8 from the printing position L2 to a paper output tray 7 along the third transport path P3. In the embodiment, a first turning point T1 is formed between the second transport path P2 and the third transport path P3, and the driving-and-controlling module 20 selects to flip or eject the transported paper 8 at the first turning point T1. In the embodiment, a second turning point T2 is formed between the second transport path P2 and the first transport path P1. The driving-and-controlling module 20 reloads another unused side of the paper 8 at the second turning point T2 for the printing device 10 to perform the printing operation. In the embodiment, the first turning point T1 is located behind the printing position L2, and the second turning point T2 is located in front of the printing position L2. In the embodiment, the image-capturing module 30 and the image-processing module 40 are located between the second turning point T2 and the paper cassette 9. It is beneficial to constructing the image-capturing module 30 and the image-processing module 40 relative to the first transport path P1 of the driving-and-controlling module 20. Certainly, the present disclosure is not limited thereto.

In the embodiment, when the printing operation performed by the printing device 10 is a double-sided printing operation, the driving-and-controlling module 20 can determine the transport path of the paper 8 based on the image features of the paper 8, and determine whether the printing device 10 uses the paper 8 to perform the printing operation. When the front side of the paper 8 and the reverse side of the paper 8 are determined to be in the unused state, the driving-and-controlling module 20 transports the paper 8 to the printing position L2 along the first transport path P1 for the printing device 10 to perform the printing operation on the front side of the paper 8. Then, the driving-and-controlling module 20 transports the paper 8 and flips the front side of the paper 8 as the reverse side along the second transport path P2, and the paper 8 is transported to the printing position L2 again for the printing device 10 to perform the printing operation on the other side of the paper 8, so that the double-sided printing operation is achieved. When either the front side or the reverse side of the paper 8 is determined to be in the used state, the driving-and-controlling module 20 takes the paper 8 away from the printing position L2 along the third transport path P3, and ejects the paper 8 to the paper output tray 7. At the same time, the driving-and-controlling module 20 further loads another paper 8′ from the paper cassette 9. The printer paper management system 1 will process the paper 8′according to the aforementioned process. It will not be redundantly described again.

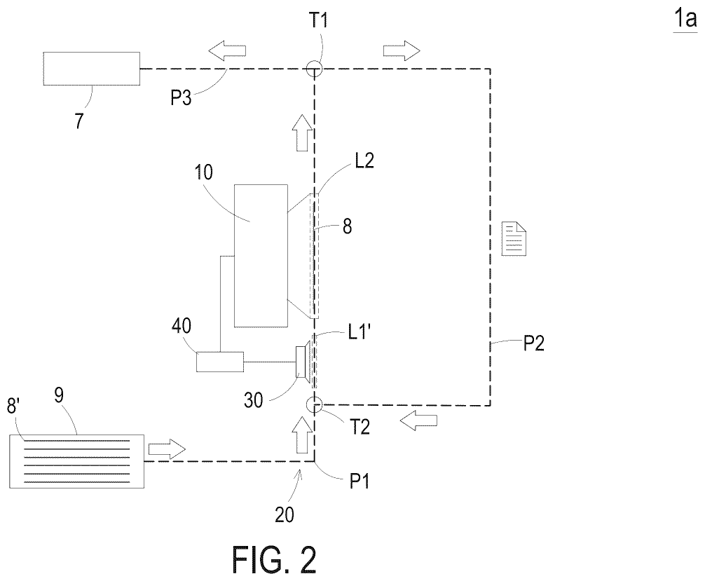

FIG. 2 is a schematic structural diagram illustrating a printer paper management system according to a second embodiment of the present disclosure. Referring to FIG. 2, in the embodiment, the printer paper management system 1a includes a printing device 10, a driving-and-controlling module 20, an image-capturing module 30 and an image-processing module 40. The printing device 10 is configured to perform a single-sided printing operation or a double-sided printing operation in the printing position L2. The driving-and-controlling module 20 is connected to the printing device 10 to transport a paper 8 from a paper cassette 9 to the printing position L2 for the printing device 10 printing on a front side of the paper 8. Moreover, the driving-and-controlling module 20 allows the front side of the paper 8 to be turned over as a reverse side. The image-capturing module 30 is arranged between the paper cassette 9 and the printing position L2 of the printing device 10, and configured to capture an image of the paper 8 before the paper 8 is transported from the paper cassette 9 to the printing position L2. The image-processing module 40 is connected to the image-capturing module 30 and the driving-and-controlling module 20, receives and pre-processes the image of the paper 8 to extract image features for transmitting to the driving-and-control module 20. In the embodiment, the driving-and-controlling module 20 determines whether to use the paper 8 based on the image features for a printing operation, or to take the paper 8 away from the printing position L2 or to flip the paper 8.

In the embodiment, the image-capturing module 30 includes only one single camera or one scanning element, which is configured to capture an image of the paper 8 when the driving-and-controlling module 20 transports the paper 8 to pass through the image-capturing position L1′ of the image-capturing module 30. In other words, the image-capturing module 30 captures the front image of the paper 8 when the paper 8 is transported through the image-capturing position L1′, so that the driving-and-controlling module 20 can determine whether the front side of the paper 8 is in the used state or the unused state. When the front side of the paper 8 is determined to be in the used state, the driving-and-controlling module 20 flips the front side of the paper 8 as the reverse side and transports the paper 8 to the printing position L2 again. Notably, in the embodiment, the image-capturing module 30 is further located between the second turning point T2 and the printing position L2. In this way, the driving-and-controlling module 20 can flips the paper 8 to another side and then transports the paper 8 through the image-capturing position L1′ of the image-capturing module 30 before being transported to the printing position L2, so that the image-capturing module 30 and the image-processing module 40 are allowed to identify the usage status of the other side of the paper 8 and then determine whether to use the other side of the paper 8 for printing operations. Certainly, in other embodiments, the driving-and-controlling module 20 omits the paper turning function of the second transport path P2. When the front side of the paper 8 is determined to be in the used state, the driving-and-controlling module 20 takes the paper 8 away from the printing position L2 along the third transport path P3, and ejects the paper 8 to the paper output tray 7. At the same time, the driving-and-controlling module 20 further loads another paper 8′ from the paper cassette 9. The printer paper management system 1a will process the paper 8′ according to the aforementioned process. It will not be redundantly described again.

In other embodiments, if the printing device 10 wants to perform a double-sided printing operation at the printing position L2, the image-capturing module 30 can capture the front-side image when the paper 8 is transported from the paper cassette 9 along the first transport path P1 to pass through the image-capturing position L1′. Then, the driving-and-controlling module 20 flips the paper 8 along the second transport path P2, so that the other side of the paper 8 is transport to pass through the image-capturing position L1′ to capture the image thereof. Thereby, the printer paper management system 1a can determine whether to use the paper 8 for the double-sided printing operation after obtaining the usage status of both sides of the paper 8. Certainly, the present disclosure is not limited thereto.

Notably, in the aforementioned embodiments, the installation positions of the image-capturing module 30 and the image-processing module 40 are adjustable according to the practical requirements. The image-capturing positions L1, L1′ of the image-capturing module 30 are in front of the printing position L2, so that the image-capturing module 30 can capture the images first before the printing surface of the paper 8 is transported to the printing position L2. Moreover, the image-processing module 40 can receive the image to extract the image features, so that the printing surface condition of the paper is determined. In the embodiment, the image features include text areas, image areas, edges or black and white contrast. The image-processing module 40 can accurately determine the condition of the paper 8 through image features, so as to realize the function of automatic paper selection. Furthermore, regarding the image processing technology of the image-processing module 40, since AI technology has developed, the image-processing module 40 can send the relevant images to a PC or a server for judgment to increase its reliability. Certainly, the image features extracted by the printer paper management system 1, 1a through image recognition technology can further cooperate with the printing device 10 to perform various sorted printing operations at the printing position L2. The present disclosure is not limited thereto and not redundantly described hereafter.

In summary, the present disclosure provides a printer paper management system using image recognition technology to automatically detect whether the paper has been used and select an unused side for printing, so that the paper consumption is sufficiently reduced and the work efficiency is improved. It conforms to the current society's emphasis on environmental protection and helps promote the development of green offices. In the printer paper management system of the present disclosure, an image-capturing module, such as a pair of cameras or a pair of scanning elements, is placed on the conveyance path between the paper tray and the printing position, and images of the front side and the back side of the paper are captured before the paper reaches the printing position. The images of the front side and the back side of the paper are received and processed by an image-processing module to extract the image features and determine the usage status of the front side and the back side of the paper. Based on the image features, the driving-and-controlling module can determine whether to print on the current paper, automatically turn pages for use, or eject the paper and load another paper for printing. Regardless of whether it is a single-sided printing operation or a double-sided printing operation, the printer paper management system can automatically detect and select the paper for printing, so as to greatly improve the work efficiency. The image-processing module uses precise image recognition technology and image processing algorithms to preprocess the images, and the text, images and other features on the paper are analyzed to extract the useful image features. It can accurately determine the usage status of the paper and execute the printing operation accordingly. The paper waste is sufficiently reduced. It has advantages of complying with environmental protection trends, and reducing the burden on the environment. On the other hand, through the automatic paper selection function of the printer paper management system, the users do not need to perform manual selection operations, and can also avoid problems such as paper misplacement, misprinting, and reprinting. It provides the users with a smarter and more convenient printing experience. The present disclosure includes the industrial applicability and the inventive steps.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A printer paper management system, comprising:
a printing device, configured to perform a printing operation in a printing position;
a driving-and-controlling module, connected to the printing device to transport a paper from a paper cassette to the printing position for the printing device printing on a front side of the paper, wherein the driving-and-controlling module allows the front side of the paper to be turned over as a reverse side;
an image-capturing module, arranged between the paper cassette and the printing position, and configured to capture an image of the paper before the paper is transferred from the paper cassette to the printing position; and
an image-processing module, connected to the image-capturing module and the driving-and-controlling module, receiving and processing the image of the paper to extract image features for transmitting to the driving-and-control module, wherein the driving-and-controlling module determines whether to use the paper based on the image features for a printing operation.

2. The printer paper management system according to claim 1, wherein the driving-and-controlling module determines whether the front side of the paper is in a used state or an unused state based on the image features.

3. The printer paper management system according to claim 2, wherein when the front side of the paper is determined to be in the unused state, the driving-and-controlling module transports the paper to the printing position for the printing device to perform the printing operation on the front side of the paper.

4. The printer paper management system according to claim 2, wherein when the front side of the paper is determined to be in the used state, the driving-and-controlling module flips the front side of the paper to become the reverse side, and transfers the paper to the printing position for the printing device to perform the printing operation on another side of the paper.

5. The printer paper management system according to claim 2, wherein when the front side of the paper is determined to be in the used state, the driving-and-controlling module takes the paper away from the printing position, and the driving-and-controlling module loads another paper from the paper cassette.

6. The printer paper management system according to claim 1, wherein the driving-and-controlling module transports the paper from the paper cassette to the printing position along a first transport path, and the image-capturing module is arranged by a lateral side of the first transport path and spatially corresponding to the front side of the paper.

7. The printer paper management system according to claim 6, wherein the driving-and-controlling module transports the paper from the printing position to flip the paper along a second transport path before transporting the paper back to the printing position, and transports the paper from the printing position to a paper output tray along a third transport path, wherein a first turning point is formed between the second transport path and the third transport path, a second turning point is formed between the second transport path and the first transport path, and the first turning point and the second turning point are located behind the printing position and in front of the printing position, respectively.

8. The printer paper management system according to claim 7, wherein the image-capturing module is located between the second turning point and the printing position.

9. The printer paper management system according to claim 1, wherein the image features comprise text areas, image areas, edges or black and white contrast.

10. A printer paper management system, comprising:
a printing device, configured to perform a printing operation in a printing position;
a driving-and-controlling module, connected to the printing device to transport a paper from a paper cassette to the printing position for the printing device printing on a front side of the paper, wherein the driving-and-controlling module allows flipping the paper;
an image-capturing module, arranged between the paper cassette and the printing position, and configured to capture an image of the paper before the paper is transferred from the paper cassette to the printing position; and
an image-processing module, connected to the image-capturing module and the driving-and-controlling module, receiving and processing the image of the paper to extract image features for transmitting to the driving-and-control module, wherein the driving-and-controlling module determines whether to use the paper based on the image features for a printing operation.

11. The printer paper management system according to claim 10, wherein the driving-and-controlling module determines whether the front side and a reverse side of the paper are in a used state or an unused state based on the image features, respectively.

12. The printer paper management system according to claim 11, wherein when the front side of the paper is determined to be in the unused state, the driving-and-controlling module transports the paper to the printing position for the printing device to perform the printing operation on the front side of the paper.

13. The printer paper management system according to claim 11, wherein when the front side of the paper is determined to be in the used state and the reverse side of the paper is determined to be in the unused state, the driving-and-controlling module flips the paper, and transports the paper to the printing position for the printing device to perform the printing operation on the paper.

14. The printer paper management system according to claim 11, wherein when the front side of the paper and the reverse side of the paper are determined to be in the used state, the driving-and-controlling module takes the paper away from the printing position, and the driving-and-controlling module loads another paper from the paper cassette.

15. The printer paper management system according to claim 11, wherein when the front side of the paper and the reverse side of the paper are determined to be in the unused state, the driving-and-controlling module transports the paper to the printing position for the printing device to perform the printing operation on the front side of the paper, and then flips the paper and transport the paper to the printing position for the printing device to perform the printing operation on the paper, wherein the printing operation is a double-sided printing operation.

16. The printer paper management system according to claim 11, wherein when either the front side or the reverse side of the paper is determined to be in the used state, the driving-and-controlling module takes the paper away from the printing position, and the driving-and-controlling module loads another paper from the paper cassette, wherein the printing operation is a double-sided printing operation.

17. The printer paper management system according to claim 10, wherein the image-capturing module comprises a pair of cameras or a pair of scanning elements, which are spatially corresponding to each other and configured to capture the image of the paper when the driving-and-controlling module transports the paper through the image-capturing module, wherein the image includes a front-side image and a reverse-side image, wherein the driving-and-controlling module determines whether the front side of the paper is in a used state or an unused state based on the image features extracted from the front-side image; and the driving-and-controlling module determines whether a reverse side of the paper is in a used state or an unused state based on the image features extracted from the reverse-side image.

18. The printer paper management system according to claim 10, wherein the driving-and-controlling module transports the paper from the paper cassette to the printing position along a first transport path, and the image-capturing module is arranged by a lateral side of the first transport path and spatially corresponding to the front side of the paper.

19. The printer paper management system according to claim 18, wherein the driving-and-controlling module transports the paper from the printing position to flip the paper along a second transport path before transporting the paper back to the printing position, and transports the paper from the printing position to a paper output tray along a third transport path, wherein a first turning point is formed between the second transport path and the third transport path, a second turning point is formed between the second transport path and the first transport path, and the first turning point and the second turning point are located behind the printing position and in front of the printing position, respectively.

20. The printer paper management system according to claim 19, wherein the image-capturing module is located between the second turning point and the printing position.
